(19) United States
(12) Patent Application Publication
(10) Pub. No.: US 2008/0318076 A1
(43) Pub. Date: Dec. 25, 2008

(54) ALLOY FOR ORNAMENTAL ARTICLES

(75) Inventor: Silverio CERATO, Vicenza (IT)

Correspondence Address: BROWDY AND NEIMARK, P.L.L.C.;624 NINTH STREET, NW, SUITE 300, WASHINGTON, DC, 20001-5303, US

(73) Assignee: Silmar S.p.A., Romano d'Ezzelino (IT)

(21) Appl. No.: 12/100,752

(22) Filed: Apr. 10, 2008

Related U.S. Application Data
(63) Continuation-in-part of application No. PCT/IB06/02850, filed on Oct. 4, 2006.

(30) Foreign Application Priority Data
Oct. 10, 2005 (IT) PD2005A000291

(51) Int. Cl. B32B 5/00; C22C 9/04

(52) U.S. Cl. 428/544; 420/477; 420/483

(57) ABSTRACT

Alloy for ornamental articles comprising a non-precious metal base and one or more precious metal alloying elements. The latter are present in an alloy, in combination or individually, with a content by weight chosen from the range of between 0.1/1000 and 100/1000. The content by weight produces concentrations of the precious metal alloying elements mainly in phase separation structures distributed around the particles of the crystal structure of the base. This particular nanometric distribution of the precious metal alloying elements imparts to the alloy a shininess which is comparable to that of precious metal alloys.

### CROSS-REFERENCE TO RELATED APPLICATIONS

The present application is a continuation-in-part of International Application PCT/IB06/02850, filed Oct. 4, 2006, which designated the United States, and which claimed the benefit of Italian application no. PD2005A000291, filed Oct. 10, 2005. The entire contents of both of the above-identified applications are hereby incorporated herein by reference.

### FIELD OF APPLICATION

The present invention relates to alloys for ornamental articles.

The alloy according to the present invention may be advantageously used in the jewelry industry for the production of ornamental articles to be proposed as a commercial alternative to conventional jewelry made with precious metal alloys.

### BACKGROUND ART

Recently, numerous companies in the goldware processing sector, in response to the crisis currently affecting the traditional market of jewelry made with precious metals (gold, silver, platinum and palladium) and in an attempt to cater also for the lower price sectors of the market, have offered the public ornamental articles which are made with non-precious metal alloys, such as, for example, steel or brass, achieving overall a good commercial response.

This policy of offering the public low end prices therefore results in an increasingly widespread need in the sector to provide alloys which allow the production of ornamental articles which are low-cost, but nevertheless have aesthetic properties (shininess, colour, etc.) which are comparable to those of the articles obtained with precious metal alloys.

These inexpensive alloys are generally copper based, since this metal has a good corrosion resistance and, combined with opportune alloying elements, allows to produce easily workable alloys presenting a color similar to gold or, depending on the composition, to other precious metals color.

A non-precious metals alloy of this type, which presents color, tarnish resistance and mechanical properties that simulate gold, is disclosed in U.S. Pat. No. 5,599,406. The disclosed alloy consists in copper, aluminum and indium, as main ingredients, and contains not more than 3% by total weight of a precious metal.

Another example of an alloy for ornamental articles, with a golden color and a high corrosion resistance, is the precious bronze described in BE 1 011 190: the main constituents in this case are, apart from copper, tin, aluminum and yttrium.

Also patent JP 60 177141 discloses a golden copper alloy for producing ornamental articles, where workability, mechanical properties and corrosion resistance are improved by adding aluminum, iron and a noble metal.

All the cited patents refer to different kinds of copper alloys, that involve the formation of phases that can present different structures, depending on the composition, and that just simulate gold, or the precious metal in question, in color and behavior.

In a similar manner to that envisaged for jewelry made of precious metal alloys, the production of the ornamental articles made of non-precious metal alloys envisages various surface finishing operations, such as polishing, diamond-machining, barrel finishing and brushing and in some cases also plating with precious metals, typically gold and platinum. These processing operations which essentially have the purpose of improving the final aesthetic appearance and the commercial attractiveness of these articles may not, however, be too advanced or sophisticated in order to avoid increasing unduly the production costs.

Generally, therefore, these ornamental articles made of non-precious metal alloys have, as do nearly all low-cost jewelry products, a surface finish which is substantially inferior, when compared to that which can be obtained in jewelry made of precious metal alloys. These non-precious ornamental articles also tend to be subject to more pronounced corrosion compared with precious metal alloys and alloying element release phenomena which deteriorate further the surface appearance over time and may produce allergic reactions in users.

Differently, jewelry made with precious metal alloys is almost never subject to corrosion phenomena and, for the same surface finish, has a decidedly superior colour brilliance and shininess. These excellent qualities are due to the low (nanometric) surface roughness values and the low percentages of (nanometric) specific surface area which are typically encountered in alloys with high percentages of precious metals (gold, silver, platinum and palladium).

As is known, the nanometric surface roughness is a measurement of the surface state of a material and can be measured with the aid of atomic force microscopes. The low surface roughness values which can be measured in precious metal alloys (of the order of a few nm) are responsible for the superior shininess and colour brilliance of the jewelry obtained therefrom, compared to jewelry made of non-precious metal alloys, for the same surface finishing treatment.

The nanometric specific surface area is a measurement, on a nanometric level, of the surface porosity of a material and in the case of the precious metals is related to the well-known properties of catalysis, oxidation resistance and shininess of these metals. The low specific surface area percentages which can be found in precious metal alloys therefore account, at least partly, for the oxidation resistance and, above all, the corrosion resistance. This property is also particularly important from a production point of view since it allows the possibility of performing the surface finishing treatment of rough-processed jewelry using abrasive chemicals without the fear of damaging the end product.

As is well known, the abovementioned behaviour of the precious metal alloys is closely linked to the percentages of precious metals used. The greater the percentages of these metals present in the alloy, the more pronounced are the chemical and physical properties of these metals which are transferred to the said alloy.

Conventionally, however, it is known that there exist threshold percentages which are variable depending on the precious metal considered (typically 333/1000 for gold, 800/1000 for silver, 850/1000 for platinum and 500/1000 for palladium), below which the properties of the corresponding precious metal are not transferred extensively to the alloys and instead the chemical/physical properties of the other non-precious metal alloying elements (copper, zinc, etc.) present in the alloy) start to prevail in a decisive manner.

In the jewelry sector it is therefore considered that, below these percentages, it is no longer convenient to introduce precious metals into the alloy, since the final effect on the aesthetic appearance of the products would be of little significance, or even negligible.

### DISCLOSURE OF THE INVENTION

In this situation the main object of the present invention is to provide an alloy for ornamental articles having aesthetic properties comparable to those of conventional precious metal alloys and at the same time production costs comparable to those of the non-precious metal alloys used to produce ornamental articles.

Another object of the present invention is to provide an alloy for ornamental articles which may be produced in an easy and low-cost manner.

These and other objects are all achieved by the alloy for ornamental articles according to the accompanying claims.

### BRIEF DESCRIPTION OF THE DRAWINGS

The technical features of the invention, in accordance with the abovementioned object, may be clearly understood from the contents of the claims reproduced below and the advantages thereof will emerge more clearly from the detailed description which follows, provided with reference to the accompanying tables, which refer to a purely exemplary and non-limiting embodiment, in which:

FIGS. 1 and 2 show the trend, respectively, of the nanometric surface roughness values and nanometric specific surface area percentages in an alloy as a function of the percentage of gold;

FIG. 3 shows an image obtained with an atomic force microscope (AFM) of a sample of an alloy for ornamental articles according to the invention, having gold as a precious metal alloying element;

FIGS. 4 and 5 show the progression, respectively, of the nanometric surface roughness values and nanometric specific surface area percentages in an alloy as a function of the percentage of silver;

FIG. 6 is an image obtained with an atomic force microscope (AFM) of a sample of an alloy for ornamental articles according to the invention having silver as a precious metal alloying element;

FIGS. 7 and 8 show the progression, respectively, of the nanometric surface roughness values and the nanometric specific surface area percentages in an alloy as a function of the percentage of platinum; and

FIGS. 9 and 10 shows the progression, respectively, of the nanometric surface roughness values and nanometric specific surface area percentages in an alloy as a function of the percentage of palladium.

### DETAILED DESCRIPTION

The alloy according to the present invention may be advantageously used in the jewelry industry in order to produce ornamental articles which are low cost and have at the same time properties of shininess and colour brilliance entirely comparable to those of jewelry made with precious metal alloys.

According to the invention, the alloy comprises a base of non-precious metals, that is a base of non-ferrous metals, mainly copper and zinc, and one or more precious metal alloying elements, the latter being present in an alloy, in combination or individually, with a content by weight chosen from the range of between 0.1/1000 and 100/1000.

The zinc is present in the alloy with a content by weight of between 10% and 35%, advantageously between 30% and 33%, while the precious metal alloying elements may be chosen from the group comprising gold, silver, platinum and palladium.

According to the invention, the content by weight of the precious metal alloying elements chosen from the range of between 0.1/1000 and 100/1000 produces main concentrations of the precious metal alloying elements in phase separation structures distributed around the particles of the crystal structure. Surprisingly the presence of zinc into the alloy promotes a segregation of the precious metal alloying elements by the grain boundary and it has been observed that this particular nanometric distribution of the precious metal alloying elements imparts to the alloy a shininess and a brilliance entirely comparable to those of precious metal alloys.

The zinc atoms, in fact, present an atomic radius similar to the copper atomic radius while the gold and the silver atoms have bigger atomic radius: due to this difference, the copper atoms are preferentially substituted for zinc atoms in the crystal structure, forming only one phase with face-centered cubic crystal structure and promoting the gold, or the precious metals, arrangement by the grain boundary.

Since the outer part of the grains that constitute the alloy is formed by the precious metal segregation, the whole alloy simulates the color and the behavior of the precious metals better than the known non-precious alloys.

The term “precious metal alloy” must be understood as meaning here an alloy having a content by weight of precious metal equal to or greater than threshold values, which, as already mentioned previously, are fixed for gold at 333/1000, for silver at 800/1000, for platinum at 850/1000 and for palladium at 500/1000.

As already mentioned above, these values are regarded conventionally as limit values for being able to define an alloy as precious, since below these values the properties of the corresponding precious metal are not transferred extensively to the alloys, while the chemical/physical properties of the other non-precious metal alloying elements (copper, zinc, etc.) present in the alloys prevail in a decisive manner.

Advantageously, the alloy according to the invention has a shininess and a brilliance which are closer to those of precious metal alloying elements than those of the non-precious metals which form the base thereof.

On the other hand it has been found that alloys based on non-precious metals, which have a precious metal content less than 0.1/1000 or in the range of between 100/1000 and the abovementioned threshold values (333/1000 for gold, 800/1000 for silver, 850/1000 for platinum and 500/1000 for palladium), do not have a prevalent concentration of the precious metal alloying elements in phase separation structures distributed around the particles of the base crystal structure and have a shininess and brilliance typical of the non-precious metals which form the base thereof.

Unexpectedly and in particular differently from that which was thought on the basis of the current state of the art in the sector, it was also noted that there exists for each precious metal (gold, silver, platinum and palladium) a limited range in which the efficiency with which the precious metal reaches aesthetic surface properties similar or comparable to those of precious metal alloys is higher.

Advantageously, in these limited ranges, a shininess is obtained for the alloy according to the invention which is greater than that which can instead be obtained with alloys produced according to the invention having a higher precious metal content.

In the case of gold, the abovementioned limited range lies substantially between 0.5/1000 and 10/1000, with the maximum efficiency situated around 1/1000.

In the case of silver, the limited range lies, instead, between 10/1000 and 100/1000, with the maximum efficiency situated between 10/1000 and 20/1000.

In the case of platinum, the limited range lies, instead, between 0.1/1000 and 5/1000, with the maximum efficiency situated around 0.5/1000.

In the case of palladium, the limited range lies, instead, between 0.2/1000 and 10/1000, with the maximum efficiency situated around 0.5/1000.

All this has been confirmed experimentally by measurements of the nanometric surface roughness and the nanometric specific surface area, performed with an atomic force microscope on samples produced with alloys according to the invention having different precious metal contents in the alloy. In fact, as already mentioned above, the shininess of an alloy may be determined indirectly from the values of its nanometric surface roughness and its nanometric specific surface area, considering that it increases with a reduction in these two parameters.

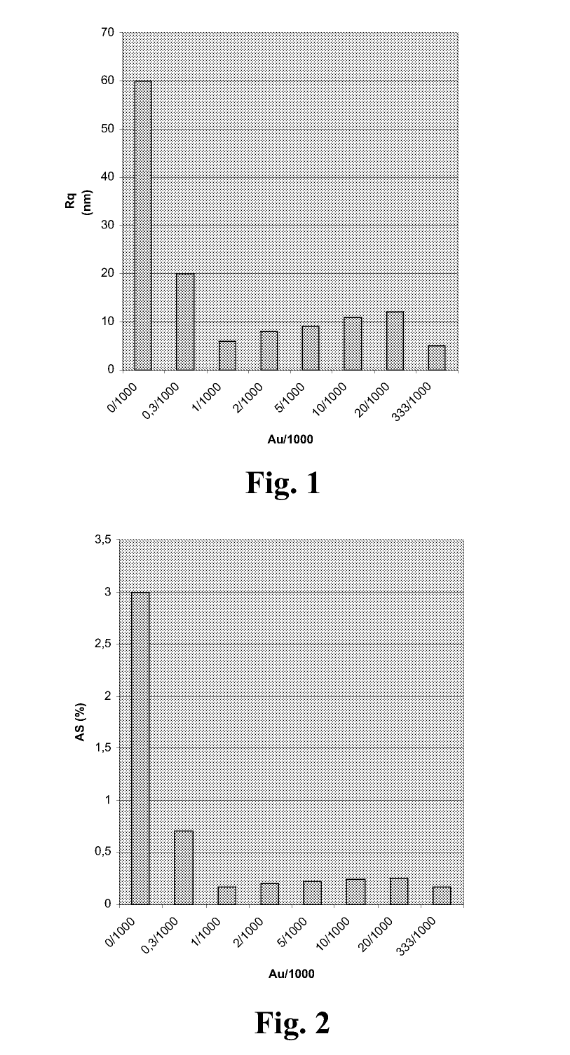

In greater detail, the behaviour of the alloys according to the invention having gold as a precious metal alloying element is illustrated by way of example in FIGS. 1 and 2, which show, respectively, the progression of the nanometric surface roughness (Rq) and the nanometric specific surfaces area (AS) compared to the gold content (expressed in thousandths, Au/1000) for an alloy according to the invention having gold as the precious metal alloying element.

In greater detail, FIG. 1 shows the nanometric surface roughness values Rq (expressed in nm) measured in some samples produced according to the invention with brass based alloys having gold contents of (0.3), (1), (5) (10) and (20) thousandths. It also shows the roughness values Rq measured in a sample made of brass (0/1000 of gold content) and in a sample made with an 8-carat gold alloy (equivalent to 333/1000), the latter being taken as a reference value for precious metal alloys containing gold.

Comparing the sample values, it can be seen that the lower roughness values (and therefore higher shininess values) are found among the samples produced according to the invention, with a gold content of between 0.5/1000 and 10/1000. In particular, it can be seen that the sample with a gold content of 1/1000 has a minimum roughness value (6 nm) of the same order of magnitude as that measured for the reference sample with 300/1000 of gold (5 nm). The brass sample instead has a roughness value which is decidedly higher.

FIG. 2 shows the surface area percentages AS measured in the same examples considered in FIG. 1. Similarly to that observed for the roughness, in the case of the surface area also it can be observed that the best values are encountered for the samples according to the invention with a gold content of between 0.5/1000 and 10/1000 and that the minimum surface area value (0.17%) is obtained for the sample with 1/1000 of gold, equivalent to that of the sample with 333/1000 of gold.

Therefore, as demonstrated by the data shown in FIGS. 1 and 2, an alloy for ornamental articles according to the invention with a gold content ranging between 0.5/1000 and 10/1000 has on average nanometric surface roughness values ranging between 5 and 15 mm and nanometric specific surface area percentages ranging between 0.10 and 0.25%. These values, which are typical of precious metal alloys containing gold, account, respectively, for the high shininess and high corrosion resistance encountered for this limited range in alloys according to the invention having gold as the precious metal alloying element.

In any case, adding to the alloy a gold content less than 0.5/1000 down to 0.1/1000 or greater than 10/1000 up to 100/1000, the shininess of the alloy remains substantially high and comparable to that of the corresponding precious metal alloys, making it possible to achieve a high efficiency with which the gold in the alloy reaches aesthetic surface properties similar or comparable to those of these precious metal alloys. As already mentioned, this is due to the particular and prevalent nanometric distribution of the gold in phase separation structures around the particles of the base crystal structure.

On the other hand, in alloys with a gold content greater than 100/1000 there is found to be no improvement in the shininess such as to justify the increase in content of this metal. In other words, exceeding the content of 100/1000 reduces the efficiency with which the gold reaches aesthetic surface properties similar or comparable to those of the corresponding precious metal alloys. In this case, the alloy is no longer mainly distributed in the abovementioned phase separation structures.

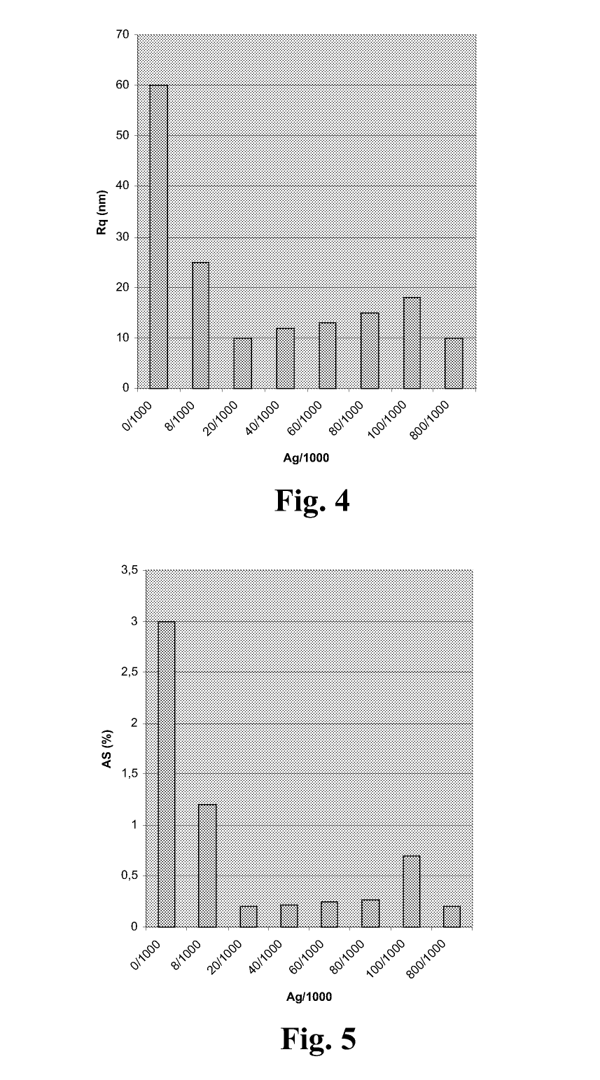

The behaviour of the alloys according to the invention having silver as the precious metal alloying element is instead illustrated, for example, in FIGS. 4 and 5 which show, respectively, the progression of the nanometric surface roughness (Rq) and the nanometric specific surface area (AS) compared to the silver content (expressed in thousandths, Ag/1000) for an alloy according to the invention.

In greater detail, FIG. 4 shows the nanometric surface roughness values Rq (expressed in nm) measured in some samples produced according to the invention with brass based alloys having silver contents of 8, 20, 40, 60, 80 and 100 thousandths. It also shows the roughness values Rq measured in a sample made of brass (0/1000 of silver content), on a sample with a silver content of 8/1000 and on a sample made with an alloy having 800/1000 of silver, the latter being taken as a reference value for precious metal alloys containing silver.

Comparing the sample values, it can be seen that the lower roughness values (and therefore higher shininess values) are found among the samples produced according to the invention, with a silver content of between 10/1000 and 100/1000. In particular, it can be seen that the sample with a silver content of 20/1000 has a minimum roughness value (about 10 nm) equivalent to that measured for the reference sample with 800/1000 of silver. The sample made of brass has a roughness value which is decidedly higher (about 60 nm).

FIG. 5 shows the surface area percentages AS measured in the same examples considered in FIG. 4. Similarly to that observed for the roughness, in the case of the surface area also it can be observed that the best values are encountered for the samples according to the invention with a silver content of between 10/1000 and 100/1000 and that the minimum surface area value is obtained for the sample with 20/1000 of silver (0.2%).

Therefore, as demonstrated by the data shown in FIGS. 4 and 5, an alloy for ornamental articles according to the invention with a silver content ranging between 10/1000 and 100/1000 has on average nanometric surface roughness values ranging between 10 and 20 mm and nanometric specific surface area percentages ranging between 0.2 and 0.7%. These values, which are typical of a precious metal alloy with a silver content greater than 800/1000 account, respectively, for the high shininess and high corrosion resistance encountered for this limited range in alloys according to the invention having silver as the precious metal alloying element.

In any case, also adding to the alloy a silver content less than 10/1000 down to 0.1/1000, the shininess of the alloy remains substantially high and comparable to that of precious metal alloys with silver, making it possible to achieve a high efficiency with which the silver in the alloy reaches aesthetic surface properties similar or comparable to those of the corresponding precious metal alloys. As already mentioned, this is due to the particular and prevalent nanometric distribution of the silver in phase separation structures around the particles of the base crystal structure.

On the other hand, in alloys with a silver content greater than 100/1000 there is found to be no improvement in the shininess such as to justify the increase in content of this precious metal. In other words, exceeding the content of 100/1000 reduces the efficiency with which the silver reaches aesthetic surface properties similar or comparable to those of these precious metal alloys. In this case, the silver is no longer mainly distributed in the abovementioned phase separation structures.

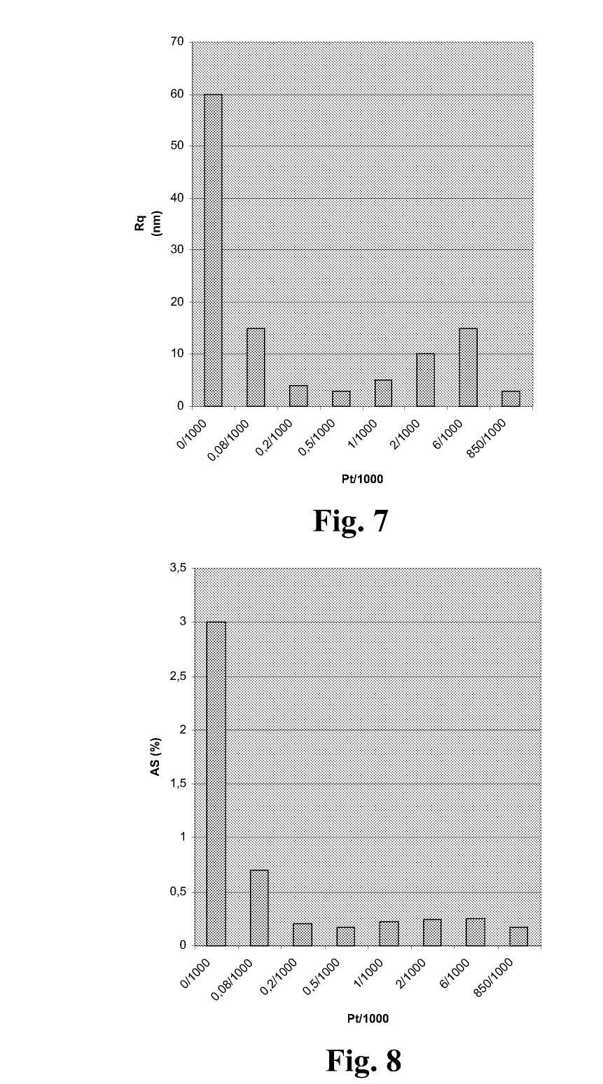

The behaviour of the alloys according to the invention having platinum as the precious metal alloying element is illustrated by way of example in FIGS. 7 and 8 which show, respectively, the progression of the nanometric surface roughness (Rq) and the nanometric specific surface area (AS) compared to the platinum content (expressed in thousandths, Pt/1000) for an alloy according to the invention having platinum as the precious metal alloying element.

In greater detail, FIG. 7 shows the nanometric surface roughness values Rq (expressed in nm) measured in some samples produced according to the invention with brass based alloys having platinum contents of (0.2), (0.5), (1) (2) and (6) thousandths. It also shows the roughness values Rq measured in a sample made of brass (0/1000 of platinum content), in a sample with a platinum content of 0.08/1000 and in a sample with a platinum content of 850/1000 of silver, the latter being taken as a reference value for precious metal alloys containing platinum.

Comparing the various samples, it can be seen that the lower roughness values (and therefore higher shininess values) can be found among the samples produced according to the invention, with a platinum content of between 0.1/1000 and 5/1000. In particular, it can be seen that the sample with a platinum content of 0.5/1000 has a minimum roughness value (3 nm) equivalent to that measured for the reference sample with 850/1000 of platinum. The brass sample instead has a roughness value which is decidedly higher (60 nm).

FIG. 8 shows the surface area percentages AS measured in the same examples considered in FIG. 7. Similarly to that observed for the roughness, in the case of the surface area also it can be observed that the best values are encountered for the samples according to the invention with a platinum content of between 0.1/1000 and 5/1000 and that the minimum surface area value (0.17%) is obtained for the sample with 0.5/1000 of platinum, equivalent to that of the sample with 850/1000 of platinum.

In any case, as already mentioned, also adding to the alloy a platinum content greater than 5/1000 up to 100/1000, the shininess of the alloy remains substantially high and comparable to that of the corresponding precious metal alloys, making it possible to achieve a high efficiency with which the platinum in the alloy reaches aesthetic surface properties similar or comparable to those of these precious metal alloys. As already mentioned, this is due to the particular and prevalent nanometric distribution of the platinum in phase separation structures around the particles of the base crystal structure.

On the other hand, in alloys with a platinum content greater than 100/1000 there is found to be no improvement in the shininess such as to justify the increase in content of this metal. In other words, exceeding the content of 100/1000 reduces the efficiency with which the platinum reaches aesthetic surface properties similar or comparable to those of the corresponding precious metal alloys. In this case, the platinum is no longer mainly distributed in the abovementioned phase separation structures.

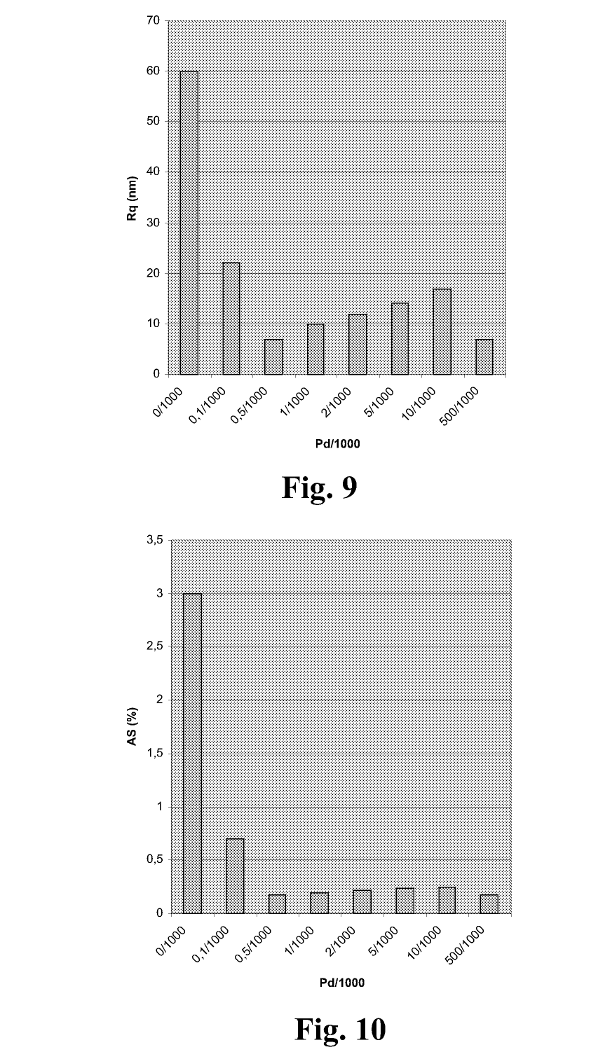

The behaviour of the alloys according to the invention having palladium as the precious metal alloying element is illustrated by way of example in FIGS. 9 and 10 which show, respectively, the progression of the nanometric surface roughness (Rq) and the nanometric specific surface area (AS) compared to the palladium content (expressed in thousandths, Pd/1000) for an alloy according to the invention having palladium as the precious metal alloying element.

In greater detail, FIG. 9 shows the nanometric surface roughness values Rq (expressed in nm) measured in some samples produced according to the invention with brass based alloys having palladium contents of (0.1), (0.5), (1) (2), (5) and (10) thousandths. It also shows the roughness values Rq measured in a sample made of brass (0/1000 of palladium content) and in a sample with a palladium content of 500/1000, the latter being taken as a reference value for precious metal alloys containing palladium.

Comparing the various samples, it can be seen that the lower roughness values (and therefore higher shininess values) are found among the samples produced according to the invention, with a palladium content of between 0.2/1000 and 10/1000. In particular, it can be seen that the sample with a palladium content of 0.5/1000 has a minimum roughness value (7 nm) equivalent to that measured for the reference sample with 500/1000 of palladium. The brass sample instead has a roughness value which is decidedly higher (60 nm).

FIG. 10 shows the surface area percentages AS measured in the same examples considered in FIG. 9. Similarly to that observed for the roughness, in the case of the surface area also it can be observed that the best values are encountered for the samples according to the invention with a palladium content of between 0.2/1000 and 10/1000 and that the minimum surface area value (0.17%) is obtained for the sample with 0.5/1000 of palladium, equivalent to that of the sample with 500/1000 of palladium.

In any case, as already mentioned, also adding to the alloy a palladium content less than 0.2/1000 down to 0.1/1000 and greater than 10/1000 up to 100/1000, the shininess of the alloy remains substantially high and comparable to that of the corresponding precious metal alloys, making it possible to achieve a high efficiency with which the palladium in the alloy reaches aesthetic surface properties similar or comparable to those of these precious metal alloys. As already mentioned, this is due to the particular and prevalent nanometric distribution of the palladium in phase separation structures around the particles of the base crystal structure.

On the other hand, in alloys with a palladium content greater than 100/1000 there is found to be no improvement in the shininess such as to justify the increase in content of this metal. In other words, exceeding the content of 100/1000 reduces the efficiency with which the palladium reaches aesthetic surface properties similar or comparable to those of the corresponding precious metal alloys. In this case, the palladium is no longer mainly distributed in the abovementioned phase separation structures.

Therefore, as demonstrated by the data shown in FIGS. 1 and 2, 4 and 5, 7-10, an alloy for ornamental articles according to the invention with a precious metal content ranging between 0.1/1000 and 100/1000 has on average nanometric surface roughness values ranging between 2 and 20 mm and nanometric specific surface area percentages ranging between 0.15 and 0.70%. These values, which are typical of precious metal alloys, account, respectively, for the high shininess and high corrosion resistance encountered for the alloys according to the invention.

As already mentioned, it was possible to observe that the precious metal alloying elements present in the alloy (gold, silver, platinum and palladium) with a content by weight chosen from the range of between 0.1/1000 and 100/1000 are concentrated mainly in phase separation structures distributed around the particles of the base crystal structure. This particular distribution of the alloying elements was not observed in alloys with a lower or higher content of precious metal alloying elements than the range of 0.1/1000 to 100/1000 and seems to account for the surprising progression measured for the roughness and surface area values upon variation in the content of precious metals in the alloy.

This particular and prevalent distribution of the precious metal alloying elements was determined as a result of observation, under an atomic force microscope (AFM), of samples of the alloy according to the invention.

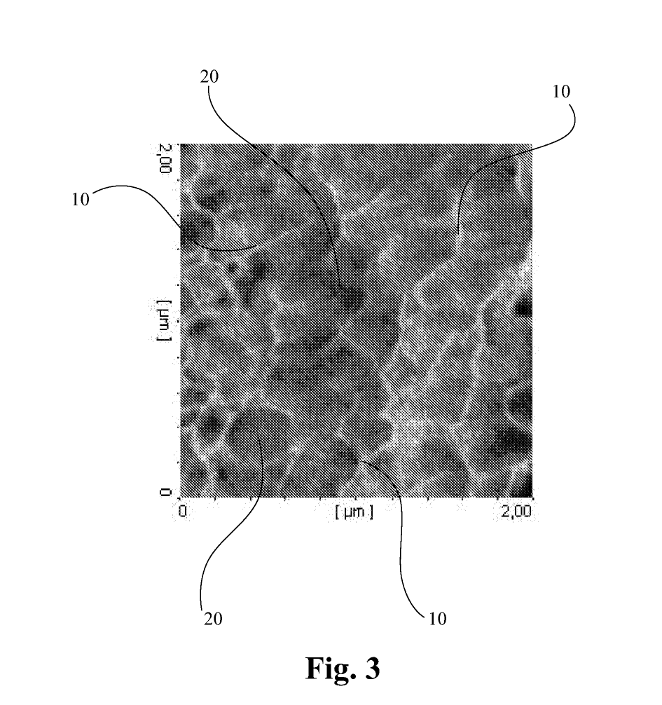

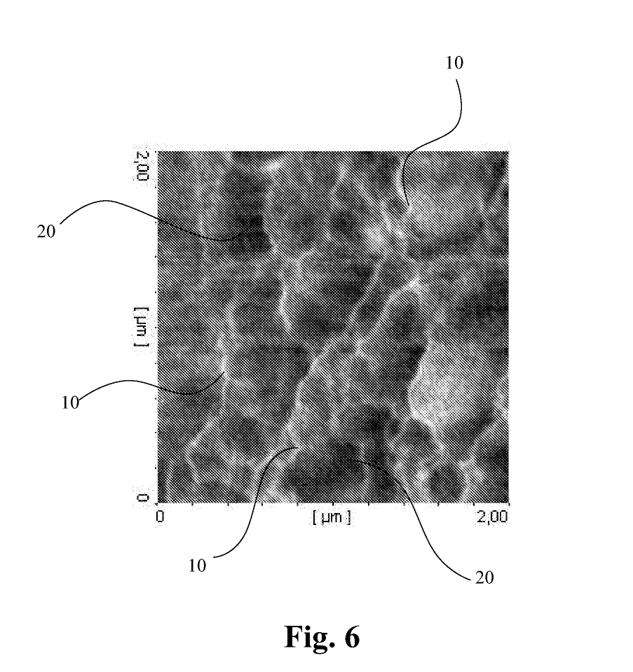

By way of example, FIGS. 3 and 6 show two images obtained with an atomic force microscope (AFM) relating to the surface of two samples produced, respectively, with an alloy according to the invention having a gold content of 1/1000 and with an alloy according to the invention having a silver content of 10/1000.

In greater detail, in FIGS. 3 and 6, it is possible to note the presence of the abovementioned phase separation structures (indicated in the Figures by 10) in the vicinity of the particles of the base crystal structure (indicated by 20). Owing to the high concentration of gold and silver, the phase separation structures 10 have a colouring which is lighter and brighter than that which the particles 20 of the base crystal structure instead have.

In accordance with a particular constructional solution, the alloy may be made by introducing gold and silver as the precious metal alloying elements, with a gold/silver weight ratio ranging between 1/10 and 2/10. It was possible to observe that, for the same overall content of precious metals, the alloy thus obtained has substantially the same surface roughness values as alloys according to the invention having only gold or only silver as the precious metal alloying element.

In accordance with other constructional solutions not shown here, the alloy according to the invention envisages not only the combination of gold and silver, but also other different combinations of the precious metals mentioned, namely, gold, silver, platinum and palladium.

The alloy according to the invention allows the production of ornamental articles, such as, for example, necklaces, bracelets, rings, earrings, etc. which, for the same surface finish, have a final aesthetic appearance (shininess, brilliance of colours) entirely comparable to that of similar articles made with precious metal alloys. The cost of these articles, considering the very low content of precious metals, is instead comparable to that of articles made with conventional non-precious metal alloys.

Advantageously the use of the alloy according to the present invention is not limited solely to the jewelry sector, but is also applicable to other sectors, for example the sector of watches and clocks, giftware, clothing, shoes or leatherwear, which envisage the production of articles made entirely with precious or semi-precious metal alloys or provided with accessories, parts or inserts made with these alloys.

1. Alloy for ornamental articles, comprising a base of non-precious metals and one or more precious metal alloying elements, which are present in the alloy, in combination or separately, with a content by weight chosen from the range of between 0.1/1000 and 100/1000,
wherein said base of non-precious metals is a non-ferrous metals base mainly of copper and zinc;
and said content by weight producing concentrations of said precious metal alloying elements mainly in phase separation structures distributed around the particles of the crystal structure of said base so as to impart to said alloy a brightness comparable to that of precious metal alloys.

2. Alloy for ornamental articles according to claim 1, in which the content of zinc in said base is in a percentage by weight of between 10% and 35%.

3. Alloy for ornamental articles according to claim 1, in which said precious metal alloying elements are chosen from the group comprising gold, silver, platinum and palladium.

4. Alloy for ornamental articles according to claim 1, having a nanometric surface roughness ranging between 2 and 20 nm.

5. Alloy for ornamental articles according to claim 1, having a nanometric specific surface area ranging between 0.15 and 0.70%.

6. Alloy for ornamental articles according to claim 1, having a shininess closer to that of said one or more alloying elements than to that of said base.

7. Alloy for ornamental articles according to claim 1, comprising gold and silver as precious metal alloying elements, characterized in that the gold is present in the alloy with a ratio by weight compared to the silver ranging between 1/10 and 2/10.

8. Alloy for ornamental articles, comprising a base of non-precious metals and gold as the alloying element, the latter being present in the alloy with a content by weight of between 0.5/1000 and 10/1000,
wherein said base of non-precious metals is a non-ferrous metals base mainly of copper and zinc;
and said content by weight producing concentrations of said precious metal alloying elements mainly in phase separation structures distributed around the particles of the crystal structure of said base so as to impart to said alloy a brightness comparable to that of metal alloys with a content by weight of gold greater than 333/1000.

9. Alloy for ornamental articles according to claim 8, in which the content of zinc in said base is in a percentage by weight of between 10% and 35%.

10. Alloy for ornamental articles according to claim 8, having a nanometric surface roughness ranging between 5 and 15 nm.

11. Alloy for ornamental articles according to claim 8, having a nanometric specific surface area percentage ranging between 0.15 and 0.25%.

12. Alloy for ornamental articles, comprising a base of non-precious metals and silver as the alloying element, the latter being present in the alloy with a content by weight of between 10/1000 and 100/1000,
wherein said base of non-precious metals is a non-ferrous metals base mainly of copper and zinc;
and said content by weight producing concentrations of said precious metal alloying elements mainly in phase separation structures distributed around the particles of the crystal structure of said base so as to impart to said alloy a shininess comparable to that of alloys with a content by weight of silver equal to or greater than 800/1000.

13. Alloy for ornamental articles according to claim 12, in which the content of zinc in said base is in a percentage by weight of between 10% and 35%.

14. Alloy for ornamental articles according to claim 12, having a nanometric surface roughness ranging between 10 and 20 nm.

15. Alloy for ornamental articles according to claim 12, having a nanometric specific surface area ranging between 0.2 and 0.7%.

16. Alloy for ornamental articles, comprising a base of non-precious metals and platinum as the alloying element, the latter being present in the alloy with a content by weight of between 0.1/1000 and 5/1000,
wherein said base of non-precious metals is a non-ferrous metals base mainly of copper and zinc;
and said content by weight producing concentrations of said precious metal alloying elements mainly in phase separation structures distributed around the particles of the crystal structure of said base so as to impart to said alloy a brightness comparable to that of metal alloys with a content by weight of platinum equal to or greater than 850/1000.

17. Alloy for ornamental articles according to claim 16, in which the content of zinc in said base is in a percentage by weight of between 10% and 35%.

18. Alloy for ornamental articles according to claim 16, having a nanometric surface roughness ranging between 2 and 15 nm.

19. Alloy for ornamental articles according to claim 16, having a nanometric specific surface area percentage ranging between 0.15 and 0.25%.

20. Alloy for ornamental articles, comprising a base of non-precious metals and palladium as the alloying element, the latter being present in the alloy with a content by weight of between 0.2/1000 and 10/1000,
wherein said base of non-precious metals is a non-ferrous metals base mainly of copper and zinc;
and said content by weight producing concentrations of said precious metal alloying elements mainly in phase separation structures distributed around the particles of the crystal structure of said base so as to impart to said alloy a brightness comparable to that of metal alloys with a content by weight of palladium equal to or greater than 500/1000.

21. Alloy for ornamental articles according to claim 20, in which the content of zinc in said base is in a percentage by weight of between 10% and 35%.

22. Alloy for ornamental articles according to claim 20, having a nanometric surface roughness ranging between 5 and 50 nm.

23. Alloy for ornamental articles according to claim 20, having a nanometric specific surface area percentage ranging between 0.15 and 0.25%.
